(19) United States
(12) Patent Application Publication
(10) Pub. No.: US 2006/0072697 A1
(43) Pub. Date: Apr. 6, 2006

(54) Symmetrically articulated reactor

(75) Inventor: Charles L. Proctor II, Alachua, FL (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: PROCTOR ENGINEERING RESEARCH & CONSULTING, INC., Alachua, FL (US)

(21) Appl. No.: 10/958,235

(22) Filed: Oct. 6, 2004

(51) Int. Cl. H05H 1/22

(52) U.S. Cl. 376/100

(57) ABSTRACT

A reactor formed of an articulated substantially spherical structure alternates between an expanded state and a collapsed state based on an environment to which it is exposed. An interior space of the articulated substantially spherical structure defines a reaction space with a first volume of the reaction space associated with the expanded state and a second volume of the reaction space associated with the collapsed state. An atomic, elemental, or molecular species can be confined within the interior volume. The articulated substantially spherical structure is collapsed substantially symmetrically about the second volume and at a sufficient rate and in a sufficient time to accelerate the species to produce a reaction, such as a chemical, reaction, a fusion reaction of a fusionable species, a transformation of species and/or a combination thereof. A method to produce a reaction within the interior space of the articulated substantially spherical structure is also disclosed.

### BACKGROUND

1. Field of the Disclosure

The present disclosure relates to a chamber for a reaction and a reactor system. More specifically, the present application relates to a structure with an interior space where an environment of the structure reversibly expands and collapses the structure to precipitate a reaction of species in the interior space.

2. Description of the Related Art

In the discussion of the state of the art that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention.

Several designs of nuclear fusion reactors have been proposed. Generally, these proposals have been on the macroscale (e.g., on the meter scale or larger) for production of energy. A fundamental element of the reactor design is the geometric shape of the reactor, because of the relationship of reactor design to the fusion process including ignition of the fusion reaction and confinement of the active plasma and its corresponding instabilities.

Different designs of fusion reactors are discussed in Published U.S. Patent Application No. 2002/0101949 A1, the entire contents of which are herein incorporated by reference.

Water-driven structure transformations of nanoparticles have been observed. See Zhang et al., Nature Vol. 424, 1025 (2003), the entire contents of which are herein incorporated by reference. The observed nanoparticles have been proposed for environmental sensors.

### SUMMARY

An exemplary reactor comprises an articulated substantially spherical structure, the structure having an expanded state and a collapsed state, wherein an interior space of the articulated substantially spherical structure defines a reaction space and wherein a first volume of the reaction space is associated with the expanded state and a second volume of the reaction space is associated with the collapsed state, an environment to expand the articulated substantially spherical structure to the expanded state, and an environment to collapse the articulated substantially spherical structure from the expanded state to the collapsed state.

An exemplary reactor system comprises means for confining a species having an interior space, the means expandable to an expanded state and collapsible to a collapsed state, wherein the interior space has a first volume associated with the expanded state and a second volume associated with the collapsed state, means for expanding the confining means to the expanded state, and means for collapsing the expanded confining means to the collapsed state, wherein the collapsing means collapses the expanded confining means symmetrically about the second volume at a sufficient rate and in a sufficient time to accelerate the species to produce a reaction.

An exemplary reactor for a reaction comprises a structure with an interior space, the structure reversibly expandable and collapsable under an external bias to precipitate a reaction of species in the interior space.

An exemplary method to produce a reaction in an articulated substantially spherical structure, the structure having an expanded state and a collapsed state, wherein an interior space of the articulated substantially spherical structure defines a reaction space and wherein a first volume of the reaction space is associated with the expanded state and a second volume of the reaction space is associated with the collapsed state, the first volume greater than the second volume, comprises confining a first species in the first volume, and collapsing the reaction space from the first volume to the second volume to initiate a reaction of the first species.

As used herein, the term reaction can include a chemical reaction, a nuclear reaction, a transformation of one or more atomic, elemental or molecular species from a first species to or with a second same or different species, or combinations of such reactions and transformations. Also, as used herein, the term reactor can include any space for a reaction.

### BRIEF DESCRIPTION OF THE DRAWING FIGURES

The following detailed description of preferred embodiments can be read in connection with the accompanying drawings in which like numerals designate like elements and in which:

FIG. 1 shows an exemplary embodiment of a reactor comprising an articulated substantially spherical structure.

FIGS. 2A, 2B and 2C schematically illustrate the articulated substantially spherical structure in an expanded state (FIG. 2A), an intermediate state between fully expanded and fully collapsed (FIG. 2B) and a collapsed state (FIG. 2C).

### DETAILED DESCRIPTION

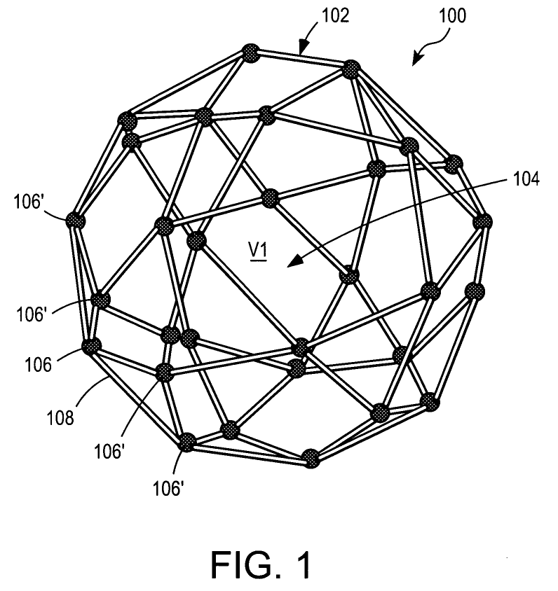

FIG. 1 is an idealized schematic illustrating an exemplary embodiment of a reactor. Exemplary reactor 100 comprises an articulated substantially spherical structure 102. An interior space 104 of the articulated substantially spherical structure 102 defines a reaction space. The articulated substantially spherical structure 102 has an expanded state and a collapsed state. A first volume of the reaction space (V1) is associated with the expanded state and a second volume of the reaction space (V2) is associated with the collapsed state.

Exemplary embodiments of articulated substantially spherical structures include nanoparticles or molecules. For example, the substantially spherical structure may be a II-VI semiconductor, such as zinc sulfide or cadmium selenium. In the exemplary embodiment of FIG. 1, the articulated substantially spherical structure 102 is a nanomolecule in which atoms 106 are articulatedly connected to neighboring atoms 106′ forming an outer shell or spherical shape, e.g., at least a portion of neighboring atoms are bonded to each other. The articulated connections 108 can be bonds between neighboring atoms in the structure that can change shape, form, or orientation at the atom position to effectively change the interior volume of the spherical structure. The bonds themselves do not necessarily bend to produce the articulation, but rather the relative positions between atoms (and by extension the orientation and length of the bonds) causes the substantially spherical structure 102 to bend and collapse/expand.

As used herein, the first volume of the reaction space (V1) is associated with the expanded state of the articulated substantially spherical structure 102, e.g., substantially when atoms 106 and nearest neighbor atoms 106′ of the articulated substantially spherical structure 102 are distributed to minimize their energy and/or to maximize their spacing. In the expanded state, the first volume of the reaction space (V1) has a diameter substantially associated with the expanded substantially spherical structure 102. Also, as used herein, the second volume of the reaction space (V2) is associated with the collapsed state of the articulated substantially spherical structure 102, e.g., substantially when the atoms 106 and nearest neighbor atoms 106′ of the articulated substantially spherical structure 102 are distributed to maximizing their energy and/or minimize their spacing. The second volume of the reaction space (V2) has a diameter substantially associated with the volume of the space enclosed by the most interior of the atoms 106 and nearest neighbor atoms 106′ of the articulated substantially spherical structure 102, e.g., a diameter (or effective diameter to distinguish from the diameter associated with V1) associated with the atom 106 and nearest neighbor atoms 106′ that have been collapsed into the most inner positions of the articulated substantially spherical structure 102.

Exemplary diameters and/or effective diameters of the first volume V1 of the interior space are less than about 500 nm, preferably less than about 100 nm to about 500 nm. In the collapsed state, exemplary effective diameters of the second volume V2 are less than one-hundredth the diameter of the first volume V1, preferably less than 1 nm, and effective volumes of the second volume V2 are less than one-millionth the volume of the first volume V1, e.g., a change on the order of more than 10⁻⁶.

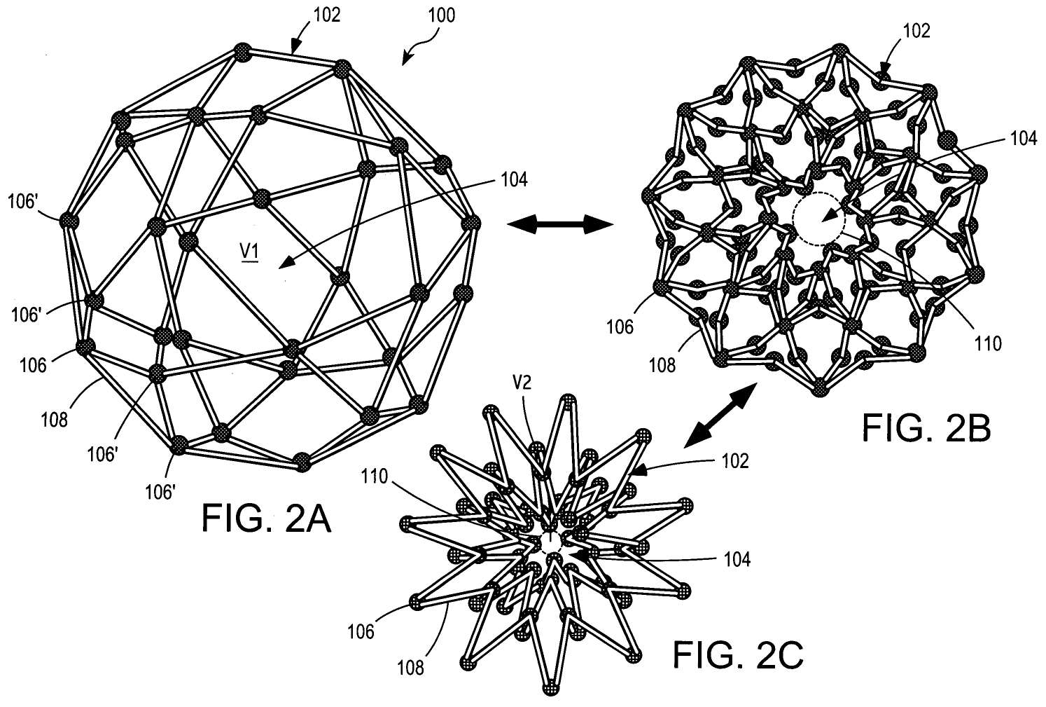

Exemplary embodiments of the reactor are in the expanded state or the collapsed state dependent on the environment to which it is exposed. For example, a change in form or shape (e.g., expanding or collapsing) of the articulated substantially spherical structure can be reversibly biased by the environment to which the atoms and bonds of the articulated substantially spherical structure are exposed. FIGS. 2A to 2C schematically illustrate in idealized form the expanded (FIG. 2A), the intermediate (FIG. 2B) and the collapsed (FIG. 2C) states of the articulated substantially spherical structure 102 in which the articulated connections 108 between atoms 106 are changing to effectively change the interior volume 104, e.g., change the volume from the first volume V1 to the second volume V2 for collapsing, and vice versa during expansion. As merely an illustrative example, an effective volume is shown in FIGS. 2B and 2C represented by a dashed line 110.

For example, a first environment biases the spherical structure to an expanded state whereas a second environment collapses the spherical structure from the expanded state to the collapsed state (or vice versa). In exemplary embodiments, this state change (e.g., the reversible expansion or collapse), may be accomplished, for example, by changing the rotational or vibrational energy state of the structure, exposing the structure to an electrical, electromagnetic, thermal, or magnetic field, or exposing the structure to a varied chemical or nuclear environment.

The rate of change of this state change may also be influenced by the biasing method. In other words, the substantially spherical structure may change state at rates depending upon the environment to which it is exposed. In one example, when exposed to water, the expanded substantially spherical structure can collapse at a rate sufficient to cause a species in the interior volume to undergo a fusion reaction. One example of a suitable species which can undergo such a reaction includes deuterium. Other examples which may be used in the exemplary embodiments disclosed herein include other light elements, such as those elements in the first three rows of the periodic table, preferably the first two rows of the periodic table, more preferably the first row of the periodic table. In addition, suitable species include isotopes, such as isotopes of hydrogen.

The reactor can optionally include means to introduce a species into the interior volume. For example, the structure may be placed in a diffusion environment. The diffusion environment is sufficient to populate the reaction space with a first species. An example of a diffusion environment is a gaseous environment.

In one exemplary embodiment, the substantially spherical articulated structure in a dry environment appears similar to a Buckminster fullerene, e.g., a Buckey ball of carbon atoms. However, the atoms are articulated or hinged and the structure does not establish a stable spherical configuration under all environmental conditions. For example, when a bipolar environment such as water is placed in contact with the surface of the structure, the structure collapses. The collapsing of the articulated structure focuses forces at a central point. In a first expanded state, the articulated structure has a volume with a diameter of approximately 100 to 500 nm. In the collapsed state, this diameter becomes less than 1/100^{th} of the expanded volume, e.g., about 1 nm. When a species is placed in the interior volume, collapsing the structure also collapses the species in the interior volume. In one example the species is an isotope of hydrogen such as deuterium and in the example the deuterium collapses and begins to repel on an atomistic level due to the repulsive forces. Further, since the collapsing of the articulated substantially spherical structure is symmetrical, the forces produced by the articulated structure are focused. As the collapsing continues, the species undergoes a reaction, such as a fusion reaction for deuterium.

In another exemplary embodiment, a species can be injected into the interior volume. Any injection method can be used. For example, a fusionable species such as deuterium can be accelerated along a tube and injected into the interior volume of the articulated substantially spherical structure. An example of such an operation includes air injection. The acceleration is generally sufficient to cause the species to penetrate a first side of the expanded structure, but is not sufficient to pass through the second side of the articulated substantially spherical structure. Thus, the species is placed in the interior volume of the structure.

Alternatively, the acceleration can be sufficient to penetrate one, two, three or more structures with a final structure being penetrated only on a first side but not on a second side to result in the species in the interior volume of an articulated substantially spherical structure. In another alternative, a species can be generally injected en masse into a volume of articulated molecules resulting in sufficient population of species in the interior volume of the molecules. Because the

A reaction promoted upon collapsing of the structure can be biased by the environment of the structure. Further, the reversible collapsing and expanding of the structure can be accomplished in a pump-like fashion, e.g., alternating collapsing-expanding, to produce repeated reactions. In exemplary embodiments in which the species in the interior volume undergoing the reaction is exothermic, the reaction and the pump-like reversible collapsing and expanding of the structure can produce energy. The energy produced per a single reactor is small in macro terms, but within a volume of reactors, such as a liter, the number of reactors is large, such that as a whole measurable and byproducts such as heat or energy can be produced on a useable scale. In one exemplary embodiment, the energy released per molecular containment vessel, or individual reactor sphere, for a tritium/deuterium fusion reaction can be on the order of, or greater than 10⁻¹¹ Joules (J). If a mole of reactors were simultaneously collapsed, the energy release would be on the order of 10¹³ J or approximately ten kilo tons of TNT.

In one example, the articulated structure in an expanded state is exposed to a diffusion environment. A species, such as fusionable species deuterium, diffuses into the interior volume due to a higher pressure or other conventional diffusion theories. The expanded articulated structure with the species in the interior volume is biased to maintain the species in the interior by storage of the structure in the environment to prevent rediffusion, e.g., to prevent the species in the interior volume from diffusing out of the interior volume. Subsequently, the structure is introduced into a collapsing environment which may be, for example, the presence or absence of some biasing environment such as water, electronic fields, magnetic fields, thermal gradient, and so forth as previously discussed. The collapsing of the structure induces the reaction of the species in the interior and produces a by-product, such as heat.

It should be noted that the articulating feature of the nanoparticle or molecule produces articulating crevices help to focus the species as the structure collapses. Further, no external heat source is used to introduce heat into the environment (i.e., no thermonuclear input for a fusionable species). Rather, the reaction is convergence based and is a result of the change in structure of the reactor molecule. However, an external heat source can optionally be used in some exemplary embodiments to enhance a particular reaction.

In another exemplary embodiment, the articulated reactor may be one of a plurality of reactors in a system. For example, multiple articulated structures can be placed in a volume and populated, expanded, and collapsed, to produce an output, such as heat.

Although preferred embodiments have been described, it will be appreciated by those skilled in the art that additions, deletions, modifications, and substitutions not specifically described may be made without department from the spirit and scope of the invention as defined in the appended claims.

What is claimed is:

1. A reactor comprising:
an articulated substantially spherical structure, the structure having an expanded state and a collapsed state, wherein an interior space of the articulated substantially spherical structure defines a reaction space and wherein a first volume of the reaction space is associated with the expanded state and a second volume of the reaction space is associated with the collapsed state;
an environment to expand the articulated substantially spherical structure to the expanded state; and
an environment to collapse the articulated substantially spherical structure from the expanded state to the collapsed state.

2. The reactor of claim 1, comprising a diffusion environment, the diffusion environment sufficient to populate the reaction space with a first species.

3. The reactor of claim 2, wherein the diffusion environment includes the environment to expand the articulated substantially spherical structure to the expanded state.

4. The reactor of claim 3, wherein the environment to expand the articulated substantially spherical structure to the expanded state includes an atmosphere of deuterium.

5. The reactor of claim 2, wherein the first species includes an atomic, elemental or molecular species.

6. The reactor of claim 1, comprising an injection device, the injection device injecting a first species into the reaction space of the articulated substantially spherical structure when the articulated substantially spherical structure is in the expanded state.

7. The reactor of claim 6, wherein the injection device includes an atmosphere of the first species at a sufficient pressure to diffuse the first species into the first volume.

8. The reactor of claim 7, wherein the first species includes an atomic, elemental or molecular species

9. The reactor of claim 7, wherein the first species includes a fusionable material.

10. The reactor of claim 9, wherein the fusionable material includes deuterium.

11. The reactor of claim 6, wherein the injection device includes an acceleration device that accelerates the first species to a sufficient speed to penetrate a first side of the articulated substantially spherical structure.

12. The reactor of claim 11, wherein the first species includes a fusionable material.

13. The reactor of claim 12, wherein the fusionable material includes deuterium.

14. The reactor of claim 11, wherein the first species includes an atomic, elemental or molecular species.

15. The reactor of claim 1, comprising a first fusionable material, a population of the first fusionable material present within the first volume sufficient to initiate a fusion event when the articulated substantially spherical structure is collapsed to the collapsed state.

16. The reactor of claim 15, wherein the first fusionable material includes deuterium.

17. The reactor of claim 15, wherein the first species includes an atomic, elemental or molecular species

18. The reactor of claim 1, wherein the articulated substantially spherical structure is a nanoparticle or a molecule.

19. The reactor of claim 1, wherein the articulated substantially spherical structure is a II-VI semiconductor.

20. The reactor of claim 19, wherein the articulated substantially spherical structure is ZnS.

21. The reactor of claim 1, wherein the articulated substantially spherical structure collapses symmetrically about the second volume from the expanded state to the collapsed state.

22. The reactor of claim 1, wherein the first volume has a diameter of less than about 500 nm.

23. The reactor of claim 22, wherein the first volume has a diameter of about 100 nm to about 500 nm.

24. The reactor of claim 22, wherein the second volume has a diameter of less than one-hundredth the diameter of the first volume.

25. The reactor of claim 1, wherein the second volume has an effective interior diameter of less than 1 nm.

26. The reactor of claim 1, wherein the environment to expand the articulated substantially spherical structure to the expanded state includes an atmosphere of a species, an electrical field, an electromagnetic field, a nuclear field or a magnetic field

27. The reactor of claim 26, wherein the atmosphere of the species is an atmosphere containing deuterium.

28. The reactor of claim 1, wherein the environment to collapse the articulated substantially spherical structure to the expanded state includes an atmosphere of a species, an electrical field, an electromagnetic field, a nuclear field or a magnetic field.

29. The reactor of claim 28, wherein the atmosphere of the species contains water.

30. A reactor system comprising a plurality of reactors according to claim 1.

31. A reaction conducted in the reactor according to claim 1.

32. A reactor system comprising:
means for confining a species having an interior space, the means expandable to an expanded state and collapsible to a collapsed state, wherein the interior space has a first volume associated with the expanded state and a second volume associated with the collapsed state;
means for expanding the confining means to the expanded state; and
means for collapsing the expanded confining means to the collapsed state,
wherein the collapsing means collapses the expanded confining means symmetrically about the second volume at a sufficient rate and in a sufficient time to accelerate the species to produce a reaction.

33. The reactor system of claim 32, comprising means for depositing the species in the interior space.

34. The reactor system of claim 33, wherein the depositing means includes a diffusion environment, the diffusion environment sufficient to populate the interior space with the species.

35. The reactor system of claim 33, wherein the depositing means includes an injection device.

36. The reactor system of claim 32, wherein the species includes an atomic, elemental or molecular species.

37. A reactor for a reaction comprising:
a structure with an interior space, the structure reversibly expandable and collapsable under an external bias to precipitate a reaction of species in the interior space.

38. The reactor of claim 37, wherein the species includes an atomic, elemental or molecular species.

39. The reactor of claim 37, wherein the articulated substantially spherical structure is a II-VI semiconductor.

40. The reactor of claim 37, wherein the articulated substantially spherical structure is ZnS.

41. A method to produce a reaction in an articulated substantially spherical structure, the structure having an expanded state and a collapsed state, wherein an interior space of the articulated substantially spherical structure defines a reaction space and wherein a first volume of the reaction space is associated with the expanded state and a second volume of the reaction space is associated with the collapsed state, the first volume greater than the second volume, the method comprising:
confining a first species in the first volume; and
collapsing the reaction space from the first volume to the second volume to initiate a reaction of the first species.

42. The method of claim 41, wherein the species includes an atomic, elemental or molecular species.

43. The method of claim 41, wherein the species includes a fusionable species, and the reaction is initiated by converging the fusionable species at a sufficient rate and in a sufficient time to cause the reaction when the reaction space collapses from the first volume to the second volume.

44. The method of claim 41, comprising expanding the structure to the expanded state prior to confining the first species.

45. The method of claim 44, wherein expanding the structure includes exposure of the structure to an expansion environment comprising an atmosphere of a species, an electrical field, an electromagnetic field, a nuclear field or a magnetic field.

46. The method of claim 45, wherein the atmosphere of the species is an atmosphere containing deuterium.

47. The method of claim 44, wherein expanding the structure includes removal of the structure from a collapsing environment comprising an atmosphere of a species, an electrical field, an electromagnetic field, a nuclear field or a magnetic field.

48. The method of claim 47, wherein the atmosphere of the species contains water.

49. The method of claim 43, wherein collapsing the reaction space includes exposure of the structure to a collapsing environment comprising an atmosphere of a species, an electrical field, an electromagnetic field, a nuclear field or a magnetic field.

50. The method of claim 49, wherein the atmosphere of the species contains water.

51. The method of claim 43, wherein collapsing the reaction space includes removal of the structure from an expansion environment comprising an atmosphere of a species, an electrical field, an electromagnetic field, a nuclear field or a magnetic field.

52. The method of claim 51, wherein the atmosphere of the species is an atmosphere containing deuterium.

53. The method of claim 43, wherein confining the first species includes diffusing the first species into the reaction space or injecting the first chemical species into the reaction space.

54. The method of claim 43, wherein the first species includes an atomic, elemental or molecular species.

55. The method of claim 43, wherein the first species includes a fusionable material.

56. The method of claim 55, wherein the fusionable material includes deuterium.

57. The method of claim 43, wherein the articulated substantially spherical structure is a nanoparticle or a molecule.

58. The method of claim 43, wherein the articulated substantially spherical structure is a II-VI semiconductor.

59. The method of claim 43, wherein the articulated substantially spherical structure is ZnS.

60. The method of claim 43, wherein the reaction space collapses symmetrically about the second volume.

61. The method of claim 43, wherein the first volume has a diameter of less than about 500 nm.

62. The method of claim 61, wherein the first volume has a diameter of about 100 nm to about 500 nm.

63. The method of claim 61, wherein the second volume has an effective interior diameter of less than one-hundredth the diameter of the first volume.

64. The method of claim 43, wherein the second volume has an effective diameter of less than 1 nm.
